(19) United States
(12) Patent Application Publication
(10) Pub. No.: US 2002/0062382 A1
(43) Pub. Date: May 23, 2002

(54) Collateral data combined with other data to select web site

(76) Inventors: Geoffrey B. Rhoads, West Linn, OR (US); Christopher Oney, Broken Arrow, OK (US); Phlipr Seder, Portland, OR (US); William Hein, Glenmoore, PA (US); James Brian Castle, Broken Arrow, OK (US)

Correspondence Address: Elmer Galbi, 13314 Vermeer Drive, Lake Oswego, OR, 97035, US

(21) Appl. No.: 10/012,676

(22) Filed: Nov. 5, 2001

Related U.S. Application Data
(63) Continuation-in-part of application No. 09/915,824, filed on Jul. 26, 2001.
(63) Continuation-in-part of application No. 09/314,648, filed on May 19, 1999.
(63) Continuation-in-part of application No. 09/342,688, filed on Jun. 29, 1999.
(63) Continuation-in-part of application No. 09/342,689, filed on Jun. 29, 1999.
(63) Continuation-in-part of application No. 09/342,971, filed on Jun. 29, 1999.
(63) Continuation-in-part of application No. 09/343,101, filed on Jun. 29, 1999.
(63) Continuation-in-part of application No. 09/343,104, filed on Jun. 29, 1999.
(63) Continuation-in-part of application No. 09/531,076, filed on Mar. 18, 2000.
(63) Continuation-in-part of application No. 09/543,125, filed on Apr. 5, 2000.
(63) Continuation-in-part of application No. 09/547,664, filed on Apr. 12, 2000.
(63) Continuation-in-part of application No. 09/552,998, filed on Apr. 19, 2000.
(63) Continuation-in-part of application No. 09/571,422, filed on May 15, 2000.
(63) Continuation-in-part of application No. 09/636,102, filed on Aug. 10, 2000.
(60) Provisional application No. 60/141,468, filed on Jun. 29, 1999.
(60) Provisional application No. 60/151,586, filed on Aug. 30, 1999.
(60) Provisional application No. 60/158,015, filed on Oct. 6, 1999.
(60) Provisional application No. 60/163,332, filed on Nov. 3, 1999.
(60) Provisional application No. 60/164,619, filed on Nov. 10, 1999.

(51) Int. Cl. G06F 15/16; G06K 9/00

(52) U.S. Cl. 709/228; 709/217; 382/100

(57) ABSTRACT

The present invention provides a system where collateral information stored in an image (or in some other data) is used together with other information such as information from a cookie on the machine used to access the collateral data, to direct a user to a particular web site. The site to which a user is directed is selected based both upon the collateral information in a web site, information from the computer that was used to read the collateral data, and information from a data base. The result is that user is directed to a web site that is more appropriate for the user at that particular time.

### RELATED APPLICATIONS

This application is a continuation in part of application Ser. No. 09/915,824 filed Jul. 26, 2001. Priority is also claimed for the following co-pending application Ser. Nos.:

09/314,648, filed May 19, 1999

09/342,688, filed Jun. 29, 1999

09/342,689, filed Jun. 29, 1999

09/342,971, filed Jun. 29, 1999

09/343,101, filed Jun. 29, 1999

09/343,104, filed Jun. 29, 1999

60/141,468, filed Jun. 29, 1999

60/151,586, filed Aug. 30, 1999

60/158,015, filed Oct. 6, 1999

60/163,332, filed Nov. 3, 1999

60/164,619, filed Nov. 10, 1999

09/531,076, filed Mar. 18, 2000

09/543,125, filed Apr. 6, 2000

09/547,664, filed Apr. 12, 2000

09/552,998, filed Apr. 13, 2000

09/571,422 filed May 15, 2000

09/636,102 filed Aug. 10, 2000

### FIELD OF THE INVENTION

The present invention relates to electronic systems and more particularly to the use of collateral data contained in an image and a data base of user information to direct a user to a particular web site.

### BACKGROUND OF THE INVENTION

Various techniques are known for embedding collateral information in images, in files of text, in audio information and in other types of digital information. Digital watermarking (which is a particular type of stenographic data encoding) is one way of imbedding collateral information in digital files. There are many types of digital watermarks. For example, issued U.S. Pat. Nos. 5,862,260, 5,841,886 and 5,809,160 describe various techniques for stenographically encoding photographs and other imagery. Prior application No. 09/127,502, filed Jul. 31, 1998, now published as WO0007356, (which is assigned to the assignee of the present invention) shows a technique by which very fine lines can be printed on a medium to slightly change the medium's apparent tint, while also conveying digital data. Co-pending application No. 09/074,034, filed May 6, 1998 describes how the contours of printed imagery can be adjusted to convey digital data. There are also other known watermarking and stenographic techniques.

The technology and science for collecting user preferences using the internet and other data gathering mechanisms is also well developed. For example U.S. Pat. Nos. 5,918,014 and 5,933,811 and PCT publication WO 00/38074 describe systems that collect data concerning users and which then selectively provides advertisements to each user based upon the particular user's interests and preferences. As used herein the terms “user characteristics” and “user's interests and preferences” means the type of user information discussed in an article entitled “Privacy 2000 In Web We Trust” published in the magazine “PC World”, June 2000, pages 103 to 108.

Systems such as the system described in co-pending application No. 09/571,422 filed May 15, 2000, utilize collateral data stored in printed images to carry a URL (Universal Resource Locator) address (or a dynamic index to a database entry storing such addresses). When a user of the system directs a camera at an image containing the collateral data, the user's web browser is directed to a particular web site.

### SUMMARY OF THE PRESENT INVENTION

The present invention provides a system where collateral information (in an image or in other data) is used together with information concerning a particular user's location or characteristics, to direct a user to a particular web site. The site to which a user is directed is selected based both upon the collateral information and information from the “cookie” on the computer that was used to read the collateral information.

In one embodiment of the invention, a user can utilize a number of different computers to read collateral data in an image. Depending upon which computer is used to read the collateral data, the user is directed to a different web site. That is, a user who has an image with collateral data can use the collateral data to access a web site using a variety of different computers. The different computers may be located at different types of locations. For example, one computer may be located in the user's home and another computer may be located in a store or kiosk which sells a particular type of product. When collateral data in the image is used to access a web site, the web site to which the user is directed depends in part on the particular computer that is used to access a web site (i.e. it depending on the information in a cookie stored on the computer used).

In another embodiment of the invention, a file or data stream includes collateral data that identifies the URL of a central web site. When a file containing the collateral data is transferred to a browser, the central web site is accessed and it interrogates a data base containing various information including user preferences. The output of the data base search is another URL that directs the browser that received the original collateral data to another web site which then sends information to the user. In still another alternate embodiment, a user uses a hand held digital camera to gather information from images such as magazine covers or product boxes. The images contain digital watermarks that carry collateral data. The collateral data is used to interrogate either a local or a remote data base which contains information pertinent to the particular user's characteristics. The output from the data base is then presented to the user. Thus, the collateral data from the original images is transformed into information particularly pertinent to the particular user.

### BRIEF DESCRIPTION OF THE FIGURES

FIG. 1 is an overall system diagram of a first embodiment of the invention.

FIG. 2 is a flow diagram of the operation of the first embodiment.

FIG. 3 is an overall system diagram of a second embodiment of the invention.

FIG. 4 is a flow diagram of the operation of the second embodiment.

FIG. 5 is a system diagram of a another embodiment the invention.

FIG. 6 illustrates still another embodiment of the invention.

### DETAILED DESCRIPTION

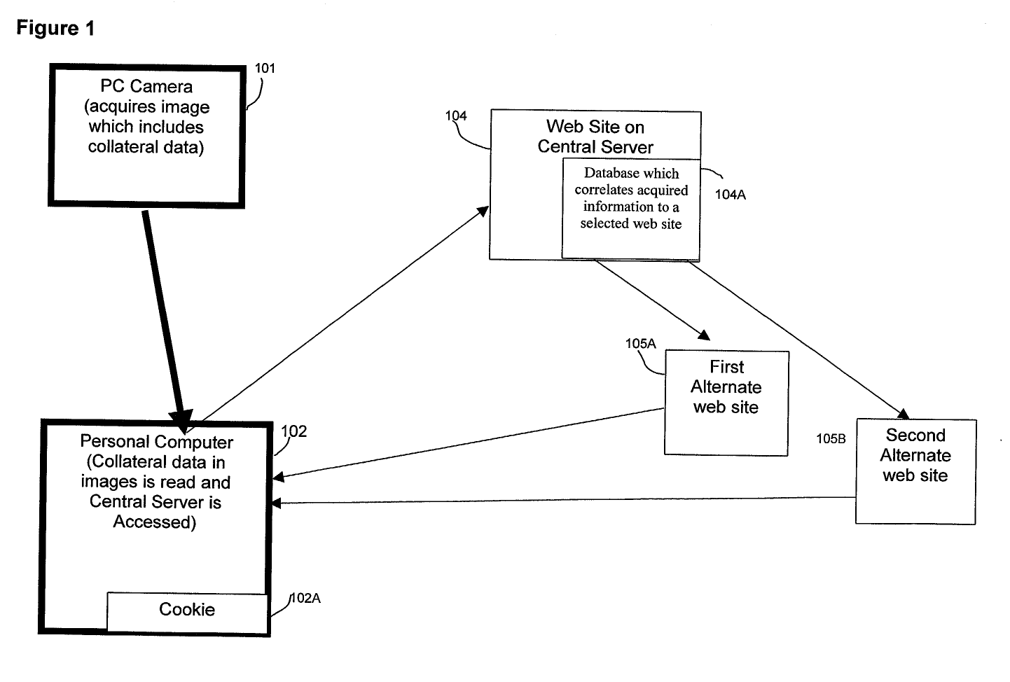

An overall system block diagram of a first embodiment of the invention is shown in FIG. 1. The system shown in FIG. 1 is designed to read collateral data from an image, and to direct a browser to a particular web site. The web site to which the browser is directed is determined by a combination of (a) the collateral data in the image (b) the information stored in a cookie on the computer which read the collateral data from the image, and (c) information in a data base that is located on a central server.

The system includes a digital camera 101 connected to a personal computer 102. Such cameras are commercially available and in widespread use. The personal computer 102 includes a browser which has a plug-in that can read digital watermarks. Such browsers and plug-ins are commercially available. For example, such a plug-in for the Microsoft Internet Explorer browser is available on a web site provided by the Digimarc Corporation. With the plug-in publicly available on the Digimarc web site, a user can hold an image containing a collateral data (i.e. an image that contains a digital watermark) in front of the PC camera 101 and the personal computer 102 will extract the collateral data and direct the computer's browser to a particular web site 104.

Personal computer 102 includes a conventional “cookie” 102A which is used to store various information. It is well known that when a web site is accessed by a browser, the web site can extract information from a “cookie” which is stored on the computer which directed the request to the web site. For example see an article entitled “Privacy 2000 in Web We Trust” published in the magazine PCWorld June 2000, page 103 to 108.

The central web site 104 has a data base 104A. Data base 104A can be accessed by the combination of (a) collateral data from an image and (b) information stored in a “cookie” 102A to generate the URL of a particular selected web site 105. That is, using the information in data base 104A, the central server 104 generates a particular URL from the combination of the collateral data in the image and data from the cookie of computer 102.

The following is an example of how the system can operate. If a user has an image that contains a digital watermark, he may use this image to access a web site from either his home computer or from a computer located in a store or some other a retail outlet such as a kiosk. If the user uses the image to access a web site from a retail outlet, it may be desirable to direct him to a certain web site whereas if he uses the image to access a web site from his home it may be desirable to direct him to a different web site. Thus, when the system reads to watermark in an image and it detects a particular “cookie” on the computer which read the watermark it will direct the browser to a particular web site, i. e. it will direct the browser to web site 105A. However, if the system does not detect the particular “cookie” on the computer which accessed the web site, it will direct the browser to a different web site, i.e. it will direct the browser to web site 105B.

In an application of the invention such as that described above, certain specific information will be stored in the “cookies” of the computers at selected retail outlets. This particular information will not be in a cookie on the computer in a user's home. Thus, when an image is used to access the system, the system will look for the certain particular information in the cookie of the system. If the information is found, the system will know that the system is being accessed from a retail store, whereas, if the particular information or data is not found in the cookie, the system will know or assume that the access request is coming from a computer other than a computer in the particular retail store.

It may also be desirable to identify the particular store from which a web site is accessed. This can be used to track commission payments, the effectiveness of advertisements, the geographic distribution of customers or for other statistical and reporting purposes. Such specific identification information can be stored in the cookies and then read and logged by server 104.

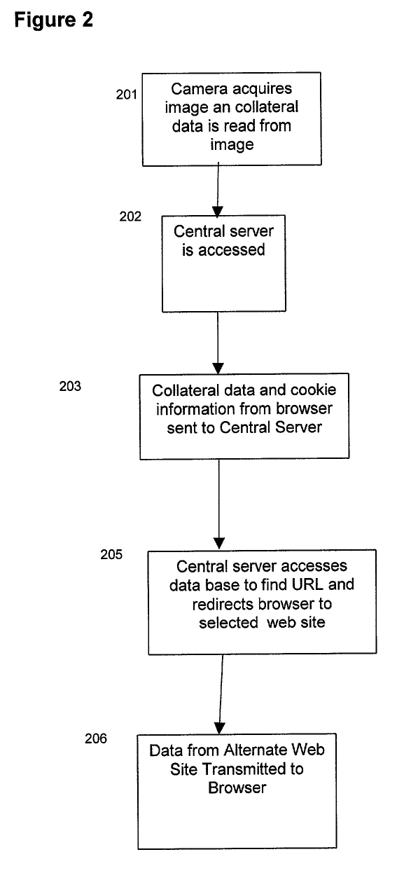

FIG. 2 is a block diagram illustrating the operation of the system. As indicated by block 201, the operation of the system begins when camera 101 acquires a digital image which contains a digital watermark. The image is first sent to a program in the personal computer 102 which reads the watermark contained in the image to obtain the data carried by the watermark. With the present invention the data in the watermark includes data that identifies the image that contained the watermark. The watermark may also carry various other information. With the present embodiment the program in computer 102 contains the URL of web site 104.

As indicated by block 202, a browser in the personal computer 102 accesses the web site 104 using a URL stored in program 102. The information obtained from the watermark is sent to web site 104. The web site also 104 reads the “cookie” 102A to obtain information concerning the location of the personal computer 102. Particular cookies 102A can be stored on selected computers. When web site 104 access a personal computer 102, it can determine if the particular computer is one on which the particular cookies were stored or if is a computer without the specified information in its cookie, thereby indicating that it is a home or other computer.

At this point in the process, the web site 104 has two pieces of information. It has the information from the watermark in the original image and it has information about the cookie on the computer which was used to read the watermark and access the web site. As indicated by block 205, these two pieces of information are used to access the data base 104A to obtain the URL that is in effect specified by these two pieces of information. The browser in computer 102 is then redirected in a conventional manner to a particular one of the web sites 105A or 105B. It is noted that in a typical system there may be many such web sites that can be specified by the data in data base 104A. The number of alternative sites is dependent upon the specific application of the system. In some systems there could be only two such web sites as shown in FIG. 1, one of which is used when particular data is in the cookie and another which is used when the particular data is not in the cookie. Alternatively, there could be a large number of such sites.

Finally, as indicated by block 206, data or a web page from the selected web site 105 is sent to the browser in personal computer 102. Various data concerning the specifics of the transaction can also be logged in the web site 104 or in the web sites 105 for use in generating various reports concerning the operations that have taken place.

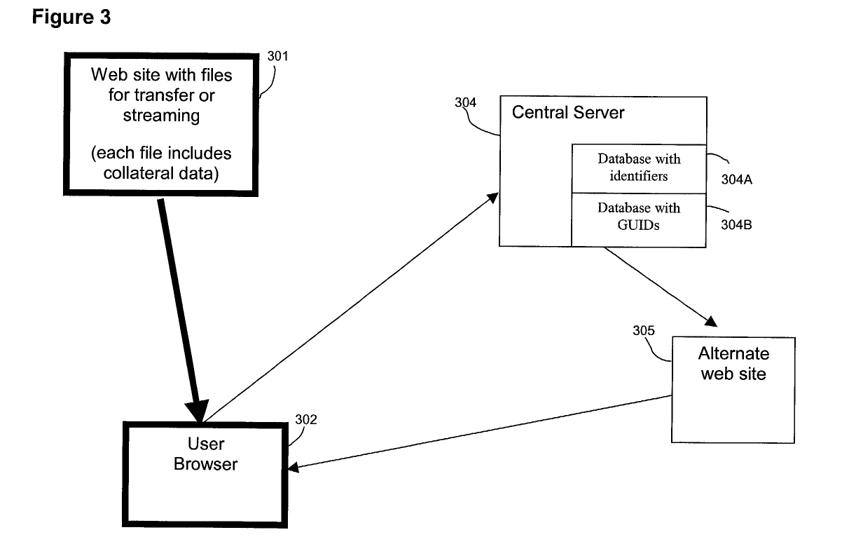

An overall system diagram of a first alternative embodiment is shown in FIG. 3. The system shown in FIG. 3 includes a conventional Internet web site 301 and an internet browser program 302 operated by a user (who is not shown in the Figure). It should be understood that when implemented on the Internet, the system would generally include many such web sites and many such browsers. The system also includes a central server 304 which includes data bases 304A and 304B. Finally the diagram shows a web site 305 which includes information of particular interest to the user of browser 302. Note, in an internet implemented system there would be a relatively large number of web sites 305, each having information for particular users that have particular sets on interest and characteristics.

The browser 302 includes a watermark reading plug in program. If a web page or a file that is sent to browser 302 contains a watermark, the watermark is detected and read by the watermark reading program in browser 302. Co-pending application No. 09/571,422 filed May 15, 2000 which is incorporated herein by reference describes such a program. It is noted that browser 302 is located in a computer and a cookie could be stored on this computer as in the first embodiment of the invention.

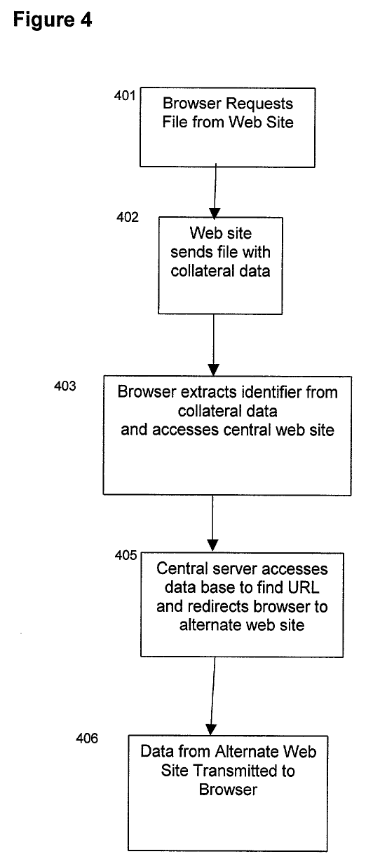

The flow diagram in FIG. 4 illustrates the operation of the system. As indicated by block 401, the process starts when browser 302 requests a file from web site 301. The file can be a text file, an audio file or an image file. The file stored on web site 301 includes collateral data. This data may be in the form of a watermark in an image or audio file or as meta data in any type of file. The simplest situation is if the requested web page contains a watermarked image. It should however be noted that the invention can work with other types of collateral data transferred from server 301 to browser 302, such as for example, when audio data is transferred.

As indicated by blocks 402 and 403, the file is sent to the browser and the browser extracts the collateral data from the file. If the data is in the form of a watermark in an image file or in audio data, the browser would utilize a plug-in which can read the watermark and extract the collateral data. The details of the watermark reading program per se are known in the art and are not part of the present invention. The collateral data extracted by the watermark reading program includes an identifier of the file or image that contained the watermark. First data base 304A is interrogated to find information concerning the organization that registered the particular watermark. This is similar to the process described in co-pending application No. 09/571,422 filed May 15, 2000.

Central server 304 also includes a second data base 304B which is indexed according to Globally Unique Identifiers (GUIDs). These identifiers allow the system to track references that come from a particular browser 302 without obtaining or using the actual name or e-mail address of the user. Such Globally Unique Identifiers (GUIDs) are in widespread use by firms that provide advertisements on the World Wide Web. For example see an article in the magazine PCWorld June 2000, page 103 to 108 entitled “Privacy 2000 in Web We Trust”. The data base 304B includes information relevant to each GUID. The information in data base 304B is acquired in a conventional manner.

The data base 304A and 304B also includes a list or data base of alternate sites 305. The data bases 304A and 304B include for each site listed, the characteristics of the users that the site owner would like to reach and the identifiers from watermarks. Thus when the collateral data in a particular image causes browser 302 to contact central server 304, the central server 304 makes two matches. First the identifier in the watermark is matched to registered identifiers to identify which particular image or web page contained the watermark. Second, from the GUID the server can determine the characteristics of the user. These two sets of information are used to determine the alternative site to which the user is directed.

The following is a very simple example which illustrates the operation of the system. Assume that the GUIDs identify only three characteristics of users that are designated “characteristic one”, “characteristic two” and “characteristic three”. Also assume that the watermarks read by browser 302 have only three different identifiers designated Identifier A, Identifier B and Identifier C. The alternative site 305 to which the user would be directed would be determined by server 304 from the information in data bases 304A and 304B as shown by the following table.

TABLE 1

| | Characteristic | Characteristic | Characteristic |
|---|---|---|---|
| | one | Two | three |
| Identifier A | Site S1 | Site S4 | Site S7 |
| Identifier B | Site S2 | Site S5 | Site S8 |
| Identifier C | Site S3 | Site S6 | Site S9 |

The point is that server 304 has available two sets of information. The first identifies the image or file from which the collateral data was obtained and the second is the characteristics of the user. These two bits of information can be combined as shown above to select an appropriate site (above identified as sites S1 to S9) to which the user should be directed.

It is specifically noted that in any practical situation there will be many more Identifiers and many more characteristics or more combinations of characteristics. Furthermore, many different combinations might point to the same web site. As shown above each different combination pints to a different web site S1 to S9.

Finally as indicated by block 406 in FIG. 4, data from the selected alternate web site 305 is sent to the browser 302. The net result of the process is that the user who requests a web page or file from web site 301 will also receive certain collateral data which may be in the form of a watermark in the web page or file. This collateral data results in a request to server 304 which using the GUID of browser 302 and information from the watermark, locates an appropriate alternate web site 305. Information from the selected alternate web site 305 is then sent to browser 302.

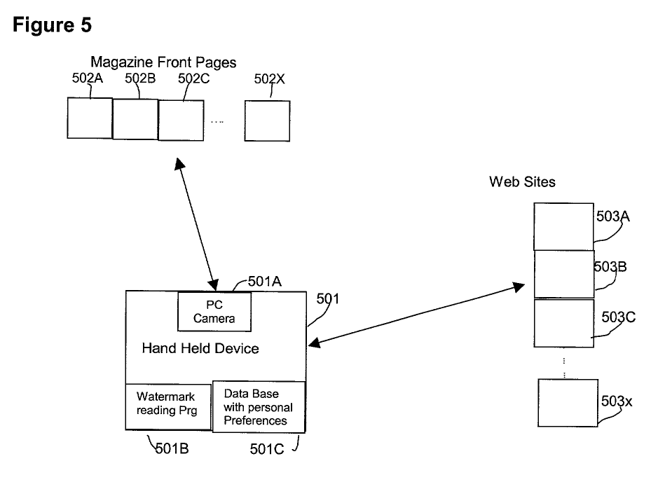

Another alternate embodiment of the invention is shown in FIG. 5. This alternate embodiment of the invention utilizes some of the components from the Media Bridge technology commercially available from Digimarc Corporation, Tualatin Oreg. With the Media Bridge technology, one can capture a digital image and read a digital watermark which is included in the image. The digital image can be captured with a commercially available PC camera.

In the embodiment shown in FIG. 5, a PC camera 501A located in a hand held device 501 captures images, which can, for example, be the front page of magazines 502A to 502X. The hand held device includes a watermark reading program 501B and a data base 501C that stores data concerning the user's personal preferences. The hand held device 501 also includes a wireless Internet connection which can connect to a web sites 503.

Each of the magazine front page images 502A to 502X includes a digital watermark which specifies a particular URL. The camera 501A reads the watermarks in the images, 502A to 502X, obtains the information from the watermark and contacts one of the web sites 503A to 503X. The particular web sites contacted depends upon the information read from the watermarks. Each web site includes an expanded index of the information in the associated magazine. This index is sent to handheld device 501. The hand held device 501 compares the information in the expanded magazine indexes to the information in the data base 501C and informs the user which particular magazine has articles which match the personal preferences stored in data base 501C.

Thus a user can scan a rack of magazine covers with device 501. Device 501 reads the URL specified by the watermark on each magazine cover and then obtains an index of the particular magazines from a remote data base. The index is compared to the user's personal preferences stored in hand held device 501 and the user is informed as to which magazine matches the stored preferences. It is noted that the designations 502A to 502X and 503A to 503X is used to illustrate that the number of magazines and the number of associated web sites is an arbitrary number suited to a particular application. The designations are meant to illustrate that there is one web site 503 (or one web page) for each magazine cover 502.

It is noted that as new issues of the various magazines appear, the information in web sites 503A to 503X change. Each magazine therefore has an identifier which directs the system to a particular web site. The web site will have the current information for that magazine.

The present embodiment goes to a different web site for each magazine index. It noted that the various magazine indexes could be stored as different web pages on a single web site.

In another alternate embodiment, the watermarks on the magazine images includes coded information about the content of the magazines. The hand held device can then compare the magazine content to the stored preferences and indicate a match without accessing a web site. In another alternate embodiment, the content can be stored in the hand held device and periodically synchronized with a remote source.

It should be specifically noted that while the foregoing example focuses on applications employing digital watermarking, the present invention can alternatively employ other data encoding techniques, including 1D and 2D barcodes, magnetic ink character recognition (MICR), optical character recognition (OCR), optical mark recognition (OMR), radio frequency identification (RF/ID), UV/IR identification technologies, data glyphs, organic transistors, magnetic stripe, etc., depending on the particular application requirements.

Co-Pending application No. 09/571,422 filed May 15, 2000 describes a system that reads collateral data and which has a router and registration data base to determine an appropriate URL when a particular object is viewed. The content of application No. 09/571,422 filed May 15, 2000 is hereby incorporated herein by reference. The present invention can be applied as an extension of the system shown in application No. 09/571,422 filed May 15, 2000.

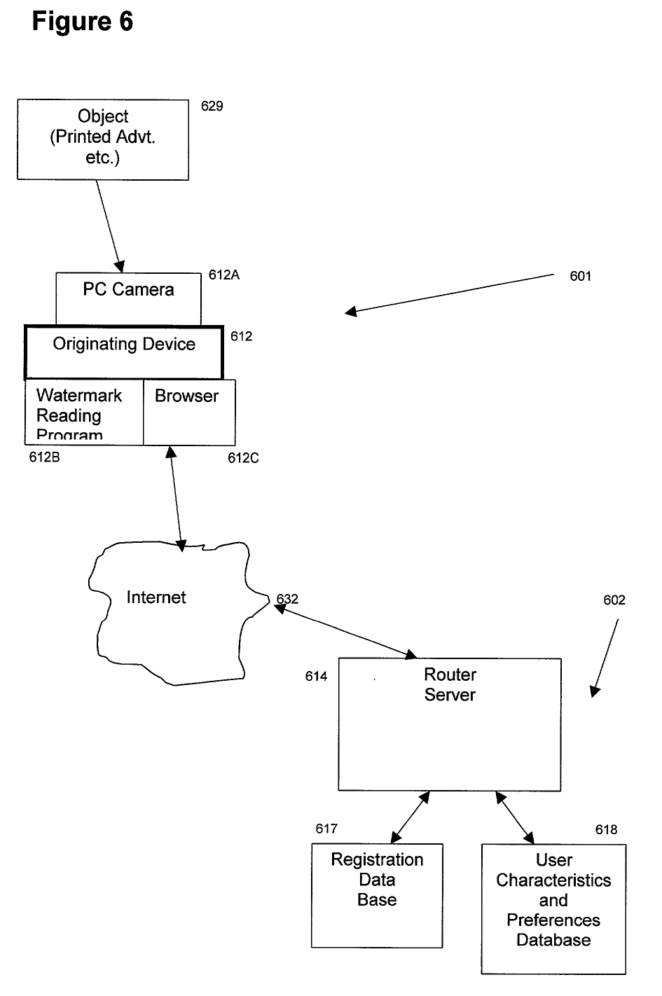

FIG. 6 illustrates another alternate embodiment of the present invention. With the system shown in FIG. 6, there is equipment 601 at a remote location connected to equipment 602 which is at a central location. A user operates an originating device 612 at the remote location. The originating device 612 includes a PC camera 612A which can acquire an electronic image of a printed advertisement 629. The originating device 612 includes a watermark reading program 612B and an internet browser 612C.

The collateral data read from the electronic image generated by camera 612A is used to generate a URL which directs the browser 612C to server 614 via the internet 632. When server 614 receives a request from originating device 612, it uses the GUID information to interrogate a data base 618 which contains information about users. The server 614 also interrogates a registration data base 617 which contains information relevant to the particular collateral data read from the object 629. These two sets of information are combined as illustrated by the simple example in table 1 above.

The sever can therefore respond to a request from originating device 612 by directing the browser 612C to a web site (not shown in FIG. 6) which is determined by both the collateral data in the object 629 and the user's characteristics and preferences in data base 618.

The content of data base 618 can be generated in any of the ways known in the art for obtaining information about particular users. It should be noted that as used herein the term “user characteristics” means any information about a user's characteristics, preferences, interests, patterns or habits. Furthermore, the term “user” in general means the person that operates or utilizes a particular terminal or system.

It is noted that in some embodiments, the system has two data bases, one of which has information relative to the user and one of which has information concerning the detected collateral data. While such embodiments have two data bases, it should be understood that these two data bases can be implemented as and considered to be a single data base. Thus, as used herein the term data base can be understood to mean a single data base or combination of multiple databases.

It should also be noted that the invention may be extended to other forms of media data such as audio and video data. For example, as a user listens to music or watches a video, digital watermarks imperceptibly embedded in the audio or video carry collateral data used to interrogate data bases and retrieve information pertinent to the particular listener or viewer.

Alternative implementations of the invention use fingerprints of the content, such as a hash of perceptually relevant features of the content, to derive a content identifier from which information particular to the user can be fetched and returned. While digital watermarks embed auxiliary data imperceptibly in the content by subtly modifying it, fingerprints are dynamically derived from the content and do not require embedding of auxiliary data. Both digital watermarks and fingerprints can be used in combination to look up related information and to find information particular to the user.

It is noted that while the first and second embodiments of the invention show data bases located in a server, these data bases could be located in a separate remote server and interrogated over the internet or over some other type of network. It is also noted that the cookies 102A and 302A can contain extensive specific information specifically identifying the machines on which they are located or they can merely contain very little information (i.e. only a single bit or a single byte) which indicates that this is a particular type of computer. Furthermore, the first and second body could also take into consideration other information about the user located in the same or in another data base when selecting a web site for the particular user.

It is also noted that while the first and second embodiments the servers 104 and 304 provide specific URL addresses. Alternatively they could merely provide data to another server that would in turn generate specific URL addresses as appropriate.

While the invention has been shown and described with respect to several different embodiments, it is noted that many other changes in form and detail can be made without departing from the sprit and scope to the invention.

I claim:

1) A method of directing a user to a particular web page, said method including, reading a watermark from an image, said watermark containing particular information,
accessing a first web server from a first computer and transmitting said particular information to said web server, said first computer containing a cookie,
determining if certain specific information is stored in said cookie,
accessing a particular web page, said particular web page being determined by the information in said watermark and information from the cookie on said first computer.

2) A method of directing a user to a particular web page, said method including,
reading a watermark from an image, said watermark containing information,
accessing a first web server from a first computer, said first computer containing a cookie, said web server containing a data base,
determining if certain specific information is stored in said cookie,
obtaining a URL from said data base based upon the information in said watermark and the information in said cookie,
providing the web page specified by said URL to said first computer.

3) The method recited in claim 2 wherein said data base contains information concerning said user's characteristics.

4) The method recited in claim 2 wherein said system includes a browser with a plug-in to read a watermark, said plug in containing the URL of said web server.

5) A system for displaying a selected web page to a user, said system including,
a watermark reading program for reading a watermark from an image, said watermark containing payload information,
a browser for accessing a first web server from a first computer, said first computer containing a cookie,
a program for determining if certain specific information is stored in said cookie,
a data base which can generate a particular URL from said payload information and from information concerning the contents of said cookie,
a program for providing said URL to said browser, whereby said browser is directed to the particular web page determined by the information in said watermark and information concerning the cookie on said first computer.

6) The system recited in claim 5 wherein said data base contains information concerning said user's preferences.

7) The system recited in claim 5 wherein said data base references a web sited based upon the particular collateral data read from a watermark and said user's characteristics.

8) The system recited in claim 5 wherein said camera is a PC camera.

9) The system recited in claim e contained in a portable computer.

10) The system recited in claim 5 wherein said a portion of said data base is at a remote location.

11) The system recited in claim 5 wherein said program for reading a watermark is a plug-in for said browser.

12) The method recited in claim 2 wherein said data base has information stored relative to Global Unique Identifiers (GUIDs).

13) The method recited in claim 2 wherein each user is identified by a GUID.

14) A method for accessing a particular web page for a user from a computer, said computer including a cookie, comprising,
acquiring an electronic image of a watermarked printed image,
reading said watermark to acquire collateral data,
interrogating a data base utilizing information concerning whether or not said cookie contains certain information and a portion of said collateral data to select a pertinent web page,
directing said user to said selected web page.

16) The method recited in claim 14 wherein said electronic image is acquired from a printed image containing a watermark.

17) The method recited in claim 14 wherein said data base is interrogated over the Internet.

18) The method provided in claim 14 wherein said user is directed to a web page by providing an URL to a web browser.
